(19) United States
(12) Patent Application Publication
(10) Pub. No.: US 2007/0277073 A1
(43) Pub. Date: Nov. 29, 2007

(54) Communication device, communication system, method of operating a communication device and ARQ feedback message

(76) Inventors: Leon J. Zegers, Amsterdam (NL); Gerrit W. Hiddink, Utrecht (NL); Marcel Korndewal, Amersfoort (NL); Richard M. Leeuwen, Zoetermeer (NL); Wim Schaap, Kortenhoef (NL)

Correspondence Address: MOTOROLA INC, 600 NORTH US HIGHWAY 45, W4 - 39Q, LIBERTYVILLE, IL, 60048-5343, US

(21) Appl. No.: 11/434,410

(22) Filed: May 15, 2006

(51) Int. Cl. H04L 1/18; G08C 25/02

(52) U.S. Cl. 714/748

(57) ABSTRACT

An ARQ feedback message provides feedback information on a series of sequential data blocks received by a receiver (26). The ARQ feedback message comprises an information element (900). The information element (900) indicates for each sequence of a plurality of sequences of the series of sequential data blocks whether each sequence of data blocks has been received. The information element comprises at least one bit for indicating that the information element provides feedback information only for sequences of data blocks beginning with a first data block of a first sequence of the plurality of sequences. The information element is a Block Sequence type information element without cumulative acknowledgement.

### FIELD OF THE INVENTION

The present invention relates to a communication device which is capable of supporting an Automatic Repeat Request (ARQ) mechanism and a communication system comprising such a communication device, a method of operating a communication device and an ARQ feedback message.

### BACKGROUND

ARQ mechanisms are well known and aim to increase the probability that data is transferred correctly from a transmitter to a receiver in a communication system by making use of feedback messages from the receiver which indicate to the transmitter whether certain data blocks of the data are to be re-transmitted.

There are different types of ARQ mechanisms, such as, for example, Stop-and Wait, Polling, Go-Back-N, Selective Repeat.

A selective repeat ARQ is a specific instance of the ARQ mechanism in which the transmitter continues to send to a receiver a number of data blocks of a series of sequential data blocks within a transmission window for a given connection. The receiver keeps track of the sequence number of the earliest data block it has not received correctly and transmits that number with an ARQ feedback message, known as an acknowledgement message (ACK), it transmits to the transmitter. The transmitter re-transmits the data blocks according to the sequence numbers identified in the ACK feedback messages. Typically, data blocks that have a state ‘waiting for retransmission’ are transmitted by the transmitter prior to data blocks that have a state ‘not sent’. The transmitter retransmits data blocks for which negative feedback is received. The transmitter retransmits data blocks for which no feedback is received and for which the retransmission timer is expired.

An ARQ mechanism with selective repeat is used in many different communication applications. For example, wireless communication devices conforming to the Worldwide interoperability for Microwave Access (WiMAX) standard as defined in the IEEE 802.16 standard, which defines a Broadband Wireless Access (BWA) system, use a selective repeat ARQ mechanism.

In the IEEE 802.16-2004 standard, a data packet is divided into a series of sequential, data blocks, each data block being assigned a Block Sequence Number (BSN). The receiver sends ARQ feedback messages to inform the originating transmitter on data blocks received correctly. ARQ feedback messages are used to communicate BSNs. Each ARQ feedback message consists of at least one Information Element (IE). An IE comprises a BSN field holding a BSN value, up to four acknowledgement mapping fields, known as the ACK MAP fields, and a ACK Type field. The ACK Type field of the IE determines how to interpret the BSN and the ACK MAP fields.

Multiple IEs are used in a ARQ feedback message if four ACK MAPs are not enough to communicate all the feedback for all the data blocks of the ARQ receiver window. This may occur when the transmission window is sufficiently large (i.e. there are a large number of data blocks to be transmitted for a single connection) and/or if a significant number of data blocks out of sequence are not received correctly by the receiver.

The current IEEE 802.16 standard (published 2004) defines four ACK Types, in other words four types of IE which can be used in ARQ feedback messages which may be transmitted from the receiver to the originating transmitter:

0x0=Selective ACK entry

0x1=Cumulative ACK entry

0x2=Cumulative with Selective ACK entry

0x3=Cumulative ACK with Block Sequence ACK entry

A Selective ACK type of feedback IE provides feedback information for each data block individually: bit maps indicate whether the corresponding data blocks have been received correctly or not.

An IE comprising a cumulative ACK with Block Sequence feedback message allows for feedback information to be provided on groups of data blocks. For example, if a group of data blocks are correctly received, a cumulative ACK with Block Sequence feedback message can identify that the whole group has been correctly received rather than addressing each data block individually. This has an advantage in that feedback can be provided on more data blocks in one IE than compared to an IE comprising a Selective ARQ feedback message. For example, an IE for which the ACK Type is set to Selective ACK (0x0), which includes four Selective ACK MAPS and which is 12 bytes long, gives feedback for 64 BSNs. An IE for which the ACK Type is set to Block Sequence (0x3), which includes four Sequence ACK MAPs, which is 12 bytes long, gives feedback for up to 512 BSNs.

The cumulative ACK types of feedback messages (i.e. ACK Types 0x1, 0x2, 0x3) is interpreted by the originating transmitter as a cumulative acknowledgement of all the data blocks assigned a BSN with a value less than the value of the BSN given in the cumulative ARQ feedback message.

As a consequence, for the situation when more than one IE is required to communicate the feedback from the receiver for all the data blocks of the ARQ receiver window of the same connection, since it is not possible to provide cumulative acknowledgement for all the preceding BSNs of the same connection since some of the preceding BSNs would have been received correctly and some incorrectly, subsequent IEs to communicate feedback for subsequent BSNs of the same ARQ receiver window may only have their ACK Type set to Selective ACK (0x0). Since Selective ACK type IEs convey feedback information individually for each data block, Selective ACK type IEs are limited in the number of data blocks for which they can provide feedback information. This means that typically multiple IEs are required in order to provide feedback on the data blocks in a receiver window. Since each IE consumes, for example, 12 bytes, as the number of IEs increases, the capacity of the communication links required for the transmission of the IEs increases.

There is a desire to reduce the number of IEs required to provide feedback in a communication device supporting an ARQ mechanism and to thereby increase the efficiency in providing feedback.

### BRIEF DESCRIPTION OF THE DRAWINGS

A communication device, a communication system, a method and an ARQ feedback message in accordance with embodiments of the invention will now be described, by way of example only, with reference to the accompanying figures in which:

FIG. 1 is a schematic diagram of a wireless communication system;

FIG. 2 is a block schematic diagram of a wireless communication device;

FIG. 3 is a schematic representation of a packet of data blocks transmitted by a transmitter to a receiver and the data blocks received by the receiver in a receiver window;

FIG. 4 is a schematic representation of a first IE for the data blocks received in the receiver window of FIG. 3;

FIG. 5 is a schematic representation of a second IE for the data blocks received in the receiver window of FIG. 3;

FIG. 6 is a schematic representation of a third IE for the data blocks received in the receiver window of FIG. 3;

FIG. 7 is a schematic representation of a fourth IE for the data blocks received in the receiver window of FIG. 3;

FIG. 8 is a schematic representation of a first IE for the data blocks received in the receiver window of FIG. 3 in accordance with an embodiment of the present invention; and

FIG. 9 is a schematic representation of a second IE for the data blocks received in the receiver window of FIG. 3 in accordance with an embodiment of the present invention.

### DETAILED DESCRIPTION

The invention will be described within the context of a wireless communication system such as a packet based cellular telephone radio communication system but it is not intended that the invention be limited to this specific type of communication system. Generally, the invention is applicable to any communication system in which connections are subject to noise/corruption of packets/frames of data and which can use an ARQ mechanism to provide more reliable transmission. For example, the invention may be used in hiperLAN communication systems.

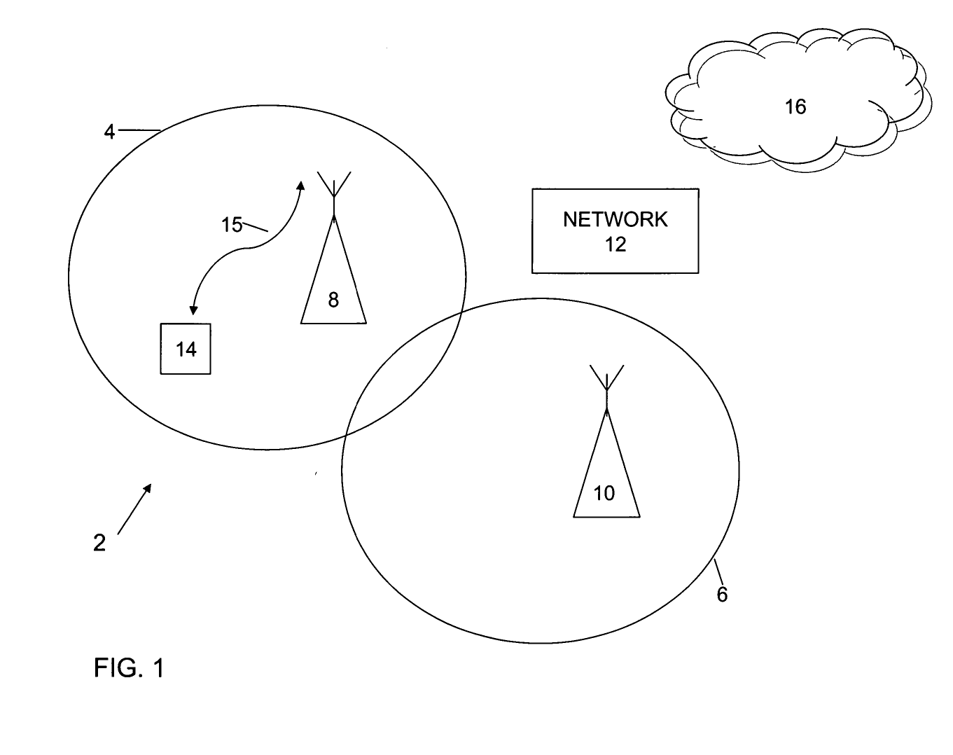

Referring now to FIG. 1, a typical packet based wireless cellular telephone radio communication system 2, which covers a geographical region, is divided into a number of cells 4, 6 (only two of which are shown in FIG. 1). Each cell is served by a respective base station 8, 10. The base stations 8, 10 are interconnected by a fixed network 12 which can communicate data between the base stations 8, 10. A communication device 14, which is often termed mobile station (MS) or subscriber unit, is served via a radio communication link 15 by the base station (BS) of the cell within which the MS 14 is situated. In the example shown in FIG. 1, the MS 14 communicates with the BS 8. The MS may be a portable or mobile telephone, a Personal Digital Assistant (PDA), and/or a portable computer.

The communication link from a BS to a MS is generally referred to as a downlink communication link or channel. Conversely, the communication link from a MS to a BS is generally referred to as an uplink communication link or channel.

The network 12 includes gateway functions for interconnecting to external networks 16, such as another cellular communication system, the Public Switched Telephone Network (PSTN) or the internet.

Such wireless communication systems are well known in the art, and therefore the specifics of such systems will not be described in detail, apart from where appropriate for the understanding of the invention as described herein.

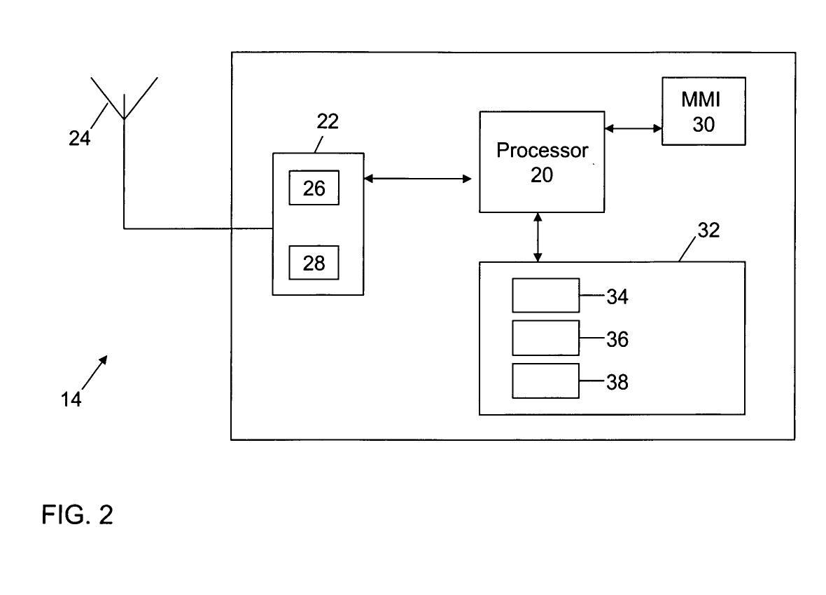

A diagram of the main functional components of an exemplary wireless communication device, such as the MS 14 of FIG. 1, in accordance with the present invention is shown in FIG. 2. As will be apparent to a skilled person, only those functional components of the MS 14 that are necessary for an understanding of the invention have been shown and will be described.

The MS 14 comprises a processor 20 for carrying out operational processing for the MS 14. The processor 20 may comprises a single processor or the functionality may be divided over several processors. The MS 14 also has a communication section 22 for providing wireless communication with the BS 8 via radio communication link 15. The communication section 22 typically includes an antenna 24, a receiver (or transceiver) 26, a transmitter (or transceiver) 28 and other elements such as a modulation/demodulation section, a coding/decoding section 28 etc as will be known to a skilled person. The communication section 22 is coupled to the processor 20.

The MS 14 also has a Man Machine Interface MMI 30, including elements such as a key pad, microphone, speaker, display screen, for providing an interface between the MS 14 and the user of the MS. The MMI 30 is also coupled to the processor 20.

The MS 14 also has a memory 32 including an operating system section 34, an applications section 36 and a file storage section 38. The operating system section 34 is arranged to store programs containing processor instructions for operation of the MS 14. The programs may contain a number of different program elements or sub-routines containing processor instructions for a variety of different tasks, for example: for exchanging signals with the BS 8 to establish a communication, for sending or receiving speech, text, multimedia or other data, for communicating with the user via the MMI 30. The application section 36 is configured to store application programs such as MPEG1 layer 3 applications, internet browsers. The file storage section 38 is configured to store data used by the operating system and application programs.

The MS 14 is configured to support ARQ mechanism. When implemented, the ARQ mechanism may be enabled on a per-connection basis. The ARQ mechanism is implemented as part of the Media Access Control (MAC) layer of the MS 14. For example, an ARQ mechanism program is stored in the operating system section 34 of the memory 32.

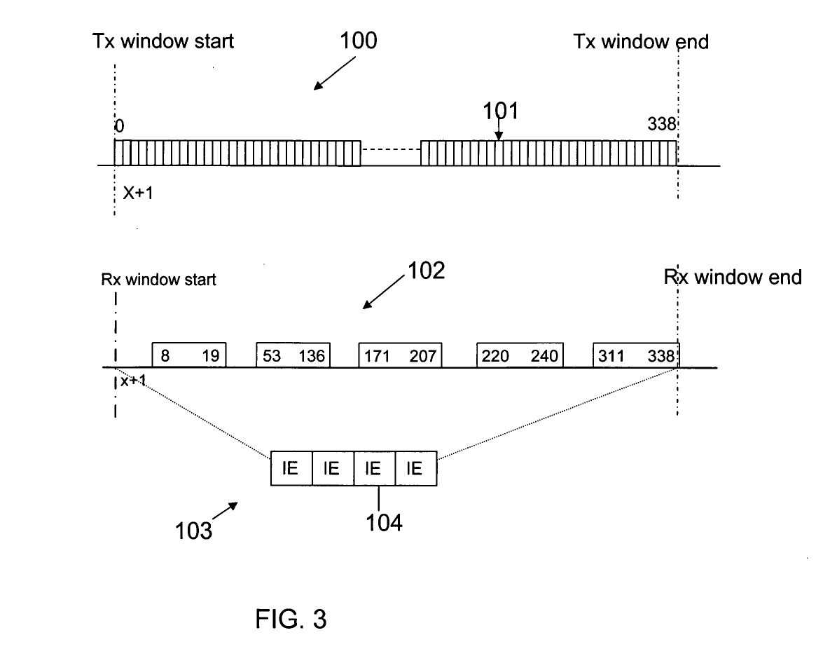

In the packet based wireless cellular telephone radio communication system 2, data is transmitted in messages or packets from a transmitter, such as BS 8, to a receiver, such as the receiver 26 of MS 14, via a downlink communication link 15. A packet of data is fragmented in to a series of sequential data blocks and each data block is assigned a BSN. FIG. 3 shows a transmission window 100 for a single connection wherein a plurality of data blocks 101 are transmitted by a transmitter in the BS 8 to the receiver 26 of the MS 14. When the receiver 26 of the MS 14 receives the data blocks, the MS 14 determines the integrity of the data blocks so that the MS 14 can determine whether each data block has been received with or without error. Such integrity checks are well known in the art.

When the ARQ mechanism is enabled in the MS 14, the MS 14 maintains a sliding ARQ receiver window 102 which is defined by a receiver window start variable and a receiver window size parameter. The start of the receiver window always points to the lowest numbered data block that has not been received correctly. A data block is received correctly when it is received without errors as determined by the integrity checks and when it has a BSN within the receiver window 102. Data blocks having a BSN outside the ARQ receiver window are still identified as having been received incorrectly even if they are determined to have been received without error. In the example shown in FIG. 3, all data blocks up to and including the BSN x have been received correctly. Thus, the start of the receiver window points to data block 0. When a data block is received correctly, the receiver window is shifted so that the start of the receiver window points to the next lowest numbered ARQ block that has not been received correctly.

The transmitter also shifts its transmission window 100 when positive feedback, indicating that the ARQ data block has been received correctly, is received from the receiver for the ARQ data block addressed by the start of the transmission window 100. The transmission window is shifted so that the start of the transmission window points to the next lowest numbered ARQ block that has not been received correctly.

Note, the transmission window 100 and receiver window 102 correspond to the same connection. However, ARQ feedback messages from the receiver can be provided over the same or different connection. A connection identifier, known as a CID, is used in the messages transmitted by the transmitter to the receiver and in the ARQ feedback messages from the receiver to the transmitter in order to indicate the connection to which the messages relate.

In the example shown in FIG. 3, the size of the receiver window 102 is set such that the receiver window 102 includes data blocks having BSNs in the range 0-338. This is by way of example. The receiver window 102 need not stop at data block 338. The data blocks which are received at the receiver 26 of the MS 14 without error are grouped: these include data blocks having BSNs 8-19, data blocks having BSNs 53-136, data blocks having BSNs 171-207, data blocks having BSNs 220-240 and data blocks having BSNs 311-338. The remaining data blocks of the 338 data blocks of the packet have not been received or have been received at the MS 14 with error and are not shown in FIG. 3.

The processor 20 generates ARQ feedback messages under the control of the relevant ARQ programs in the operating system section 34. The MS 14 provides the ARQ feedback messages for each connection via the transmitter 28 and an uplink communication link 15 to the BS 8. In an embodiment, an ARQ feedback message is sent for the entire window per connection at particular times. The ARQ feedback message holds several IEs (e.g. four) for a single connection. However, the IEEE 802.16 standard does allow for a single ARQ feedback message to hold several IEs addressing several connections. Each IE holds a CID value that addresses an unique connection. With respect to the example shown in FIG. 3, the ARQ feedback message 103 for the receiver window 102 includes multiple IEs 104 in order to cover feedback for all the 338 data blocks. The number of IEs per message will depend on the standard and the available bandwidth.

The IEs transmitted by the MS 14 to the BS 8 identify the BSNs of the data blocks which have not been received or which have been received with errors by the receiver 26. The BS 8 uses this information to re-transmit only those identified data blocks to the receiver 26 of the MS 14. In this way, the probability of transmitting all the data blocks by the BS 8 to the MS 14 is increased without having to re-transmit all of the data blocks. The data blocks are re-transmitted after a retry-timeout or when an ARQ feedback message indicates a data block has not been received correctly. Data blocks in a state ‘waiting for retransmission’ are sent to the receiver before data blocks that have a state ‘not sent’.

An example of how feedback by way of IEs generated by the processor 20 in the MS 14 can be provided to the BS 8 according to the current IEEE 802.16 standard which defines four ACK Types 0x0, 0x1, 0x2, 0x3, as discussed above, will now be described with reference to FIGS. 3-7. In the described example, four IEs are used to provide feedback information for the receiver window 102 of FIG. 3, the first one being a cumulative ACK with Block Sequence type of feedback message.

Generally, an IE includes a BSN field to hold a BSN value, up to four mapping fields, known as the ACK MAP fields, and a ACK Type field. The ACK Type field of the IE determines how to interpret the BSN and the ACK MAP fields.

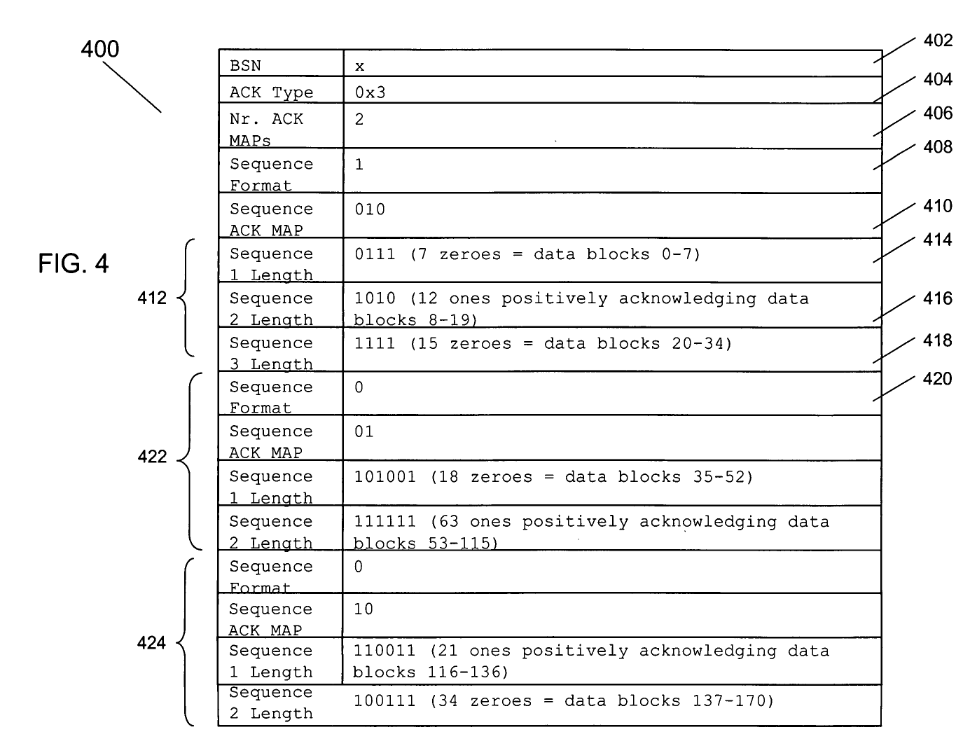

FIG. 4 shows the first IE 400 which is a cumulative ACK with Block Sequence type of feedback message. Note, a block sequence is defined as a series of data blocks with consecutive BSN values. The first IE 400 comprises a BSN field 402. For a cumulative ACK with Block Sequence type of feedback message, the value x in the BSN field denotes that all data blocks in the transmission window 100 (i.e. the same connection) up to and including data block BSN x, have been received successfully. The first IE 400 further comprises an ACK Type field 404 which has a value 0x3 to denote a cumulative ACK with Block Sequence type of feedback message, a field 406 which specifies the number of ACK MAPs, which in this example is set to two meaning three ACK MAPs will follow, a sequence format field 408 which identifies the format of the associated sequence ACK MAP (in this example, format 1 indicates that three sequence length fields will follow and the ACK MAP field will hold three bits), a sequence ACK MAP field 410, sequence length fields 412 which indicate the number of data blocks that are members of the associated sequence, each sequence length field 412 addressing up to fifteen BSNs. As mentioned above, each IE can have up to four ACK MAPs and so the fields 408-412 may be repeated up to four times in an IE. The sequence format field set to 0 indicates that two sequence length fields will follow, each addressing up to sixty three BSNs and the ACK MAP field will hold only two bits.

The sequence ACK MAP field 410 indicates a positive or negative acknowledgment for a sequence of ARQ blocks. The MSB of the sequence ACK MAP corresponds to the subsequent sequence 1 length field and if set to 1, it indicates that all BSNs addressed by this sequence are correctly received by the receiver (that is, 1 indicates a positive acknowledgement). If a bit of the sequence ACK MAP is set to 0, it indicates that the BSNs addressed by the corresponding sequence length are not correctly received by the receiver (that is, 0 indicates a negative acknowledgement). The second bit of the sequence ACK MAP corresponds to the subsequent sequence 2 length field. The third bit (if present) of the sequence ACK MAP corresponds to the subsequent sequence 3 length field. The sequence ACK MAP holds two bits in case the associated sequence format field is set to 0. The sequence ACK MAP holds 3 bits in case the associated sequence format field is set to 1.

The MSB of the ACK MAP field 410 corresponds to the first sequence length field 414 in the descriptor. The bits for succeeding length fields 416-418 are assigned left-to-right within the map entry. Since the sequence of data blocks described by the first sequence length field 414 of the first map entry of the IE 400 corresponds to the sequence of data blocks immediately after the cumulative ACK (ie. for data blocks x+1, where data block x and lesser data blocks have been cumulatively acknowledged), the ACK MAP bit for this sequence, in the example given in FIGS. 3 and 4 the sequence of data blocks 0-7, shall be zero indicating this sequence has not yet been received or has been received with errors. The IEEE 802.16 standard in fact defines that the MSB of the first sequence ACK MAP field of a cumulative ACK with Block Sequence type IE is zero.

The first sequence length field 414 corresponds to a first sequence of data blocks, 0-7, and as indicated by the MSB of the ACK MAP field 410 being set to zero, provides negative acknowledgement of the data blocks 0-7. The second sequence length field 416 corresponds to a second sequence of data blocks 8-19, and as indicated by the bit to the right of the MSB of the ACK MAP field 410 being set to one, provides positive acknowledgement of the data blocks 8-19. The third sequence length field 418 corresponds to a third sequence of data blocks 20-34 and as indicated by the last bit of the ACK MAP field 410 being set to zero, provides negative acknowledgement of the data blocks 20-34.

Fields 422 correspond to a second ACK MAP of the IE 400 and provide ARQ feedback information for data blocks 35-115 and fields 424 correspond to a third ACK MAP of the IE 400 and provide ARQ feedback information for data blocks 116-170.

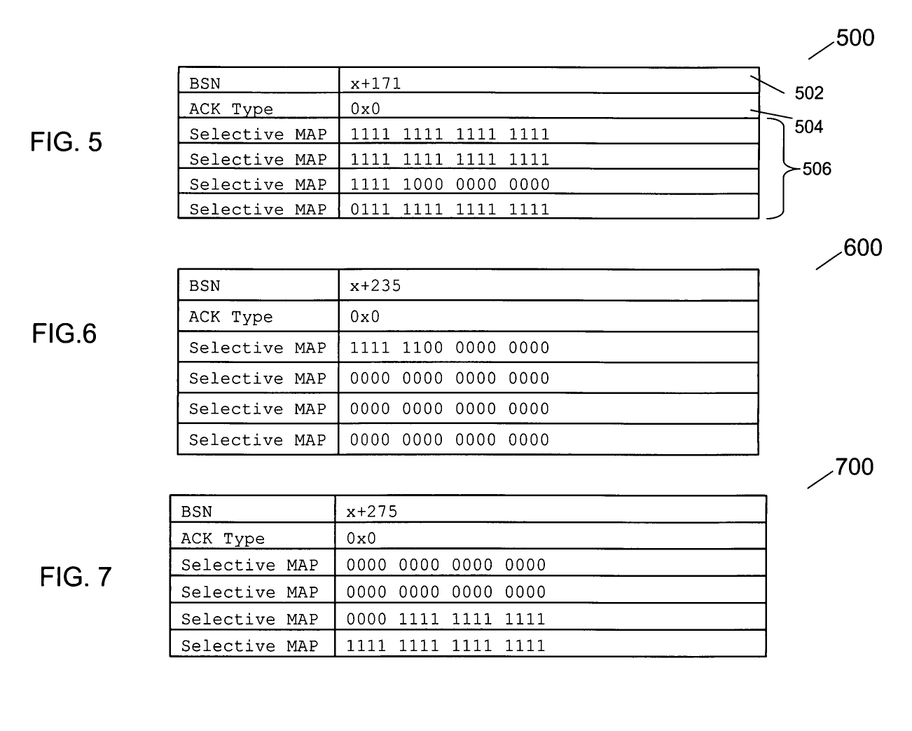

Since it is not possible to provide a cumulative ACK for the data blocks 0-170 (some data blocks have been received and others have not), as discussed in the introduction, in order to provide feedback for the remaining data blocks 171-338 in the receiver window 102, a Selective ACK type IE can only be used. A Selective ACK type IE holding four ACK MAPs, each 12 bytes long, can only address 64 data blocks. Thus, three additional Selective ACK type IEs are required in order to provide ARQ feedback on data blocks 171-338. Examples of the second, third and fourth Selective ACK type IEs for data blocks 171-338 are given in FIGS. 5-7.

The second Selective ACK type IE 500 includes an ACK Type field 504 set to 0x0 to denote it is a Selective ACK type of feedback message, a BSN field 502 set to x+171 to indicate that the second IE 500 provides feedback starting from data block 171 and selective ACK MAP fields 506. Each bit of a selective ACK MAP field 506 corresponds to a corresponding data block, the BSN number being determined by the BSN in the BSN field 502. Each bit of a selective ACK MAP field 506 is set to one to indicate the corresponding data block has been received without errors and set to zero to indicate the corresponding data block has not been received or has been received with errors. The second Selective ACK type IE 500 provides ARQ feedback information on data blocks 171-234.

The third Selective ACK type IE 600 provides ARQ feedback information on data blocks 235-274 and fourth Selective ACK type IE 700 provides ARQ feedback information on data blocks 275-338.

An IE for which the ACK Type is set to Block Sequence holding four Sequence ACK MAPs is 12 bytes long giving feedback up to 512 BSNs. So a Block Sequence ACK can potentially convey feedback for more blocks than a Selective ACK. However, according to the current ACK type encoding as defined in the current IEEE 802.16 standard, it is only possible to use a Block Sequence ACK in the first IE of a connection, because a Block Sequence ACK is always to be combined with a cumulative ACK.

Thus, when the MS 14 implements the ARQ mechanism according to the current standard, the number of IEs that are required increases as the amount of ARQ feedback increases. The larger the number of IEs, the larger capacity is required for communicating the IEs to the BS.

The inventors have recognised that ARQ feedback can be provided more efficiently when a Block Sequence ACK type of feedback message without cumulative ACK is defined and used. Since a Block Sequence ACK type IE without cumulative ACK does not provide cumulative acknowledgement of preceding BSNs, a Block Sequence ACK type IE without cumulative ACK can also be used for subsequent IEs of the same connection and hence the same transmission window.

The use of a Block Sequence ACK type IE without cumulative ACK in accordance with the invention will now be described with reference to FIGS. 3, 8 and 9 by looking again at the example shown in FIG. 3.

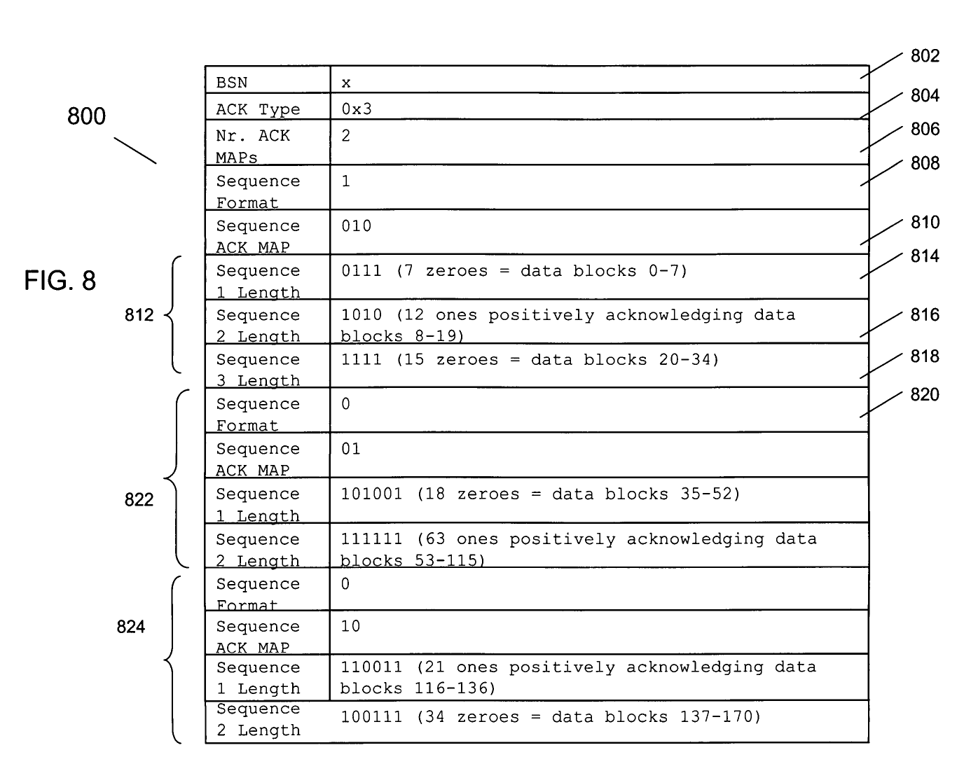

The first IE 800 for providing ARQ feedback in accordance with the present invention is generated by the processor 20. The first IE 800 is a cumulative ACK with Block Sequence type of feedback message and can have the same format as the first IE 400 shown in FIG. 4. Like elements to those in FIG. 4 are referred in FIG.8 by the same reference numeral plus the number four hundred. Accordingly, the description given above with respect to FIG. 4 applies equally to the first IE 800 shown in FIG. 8.

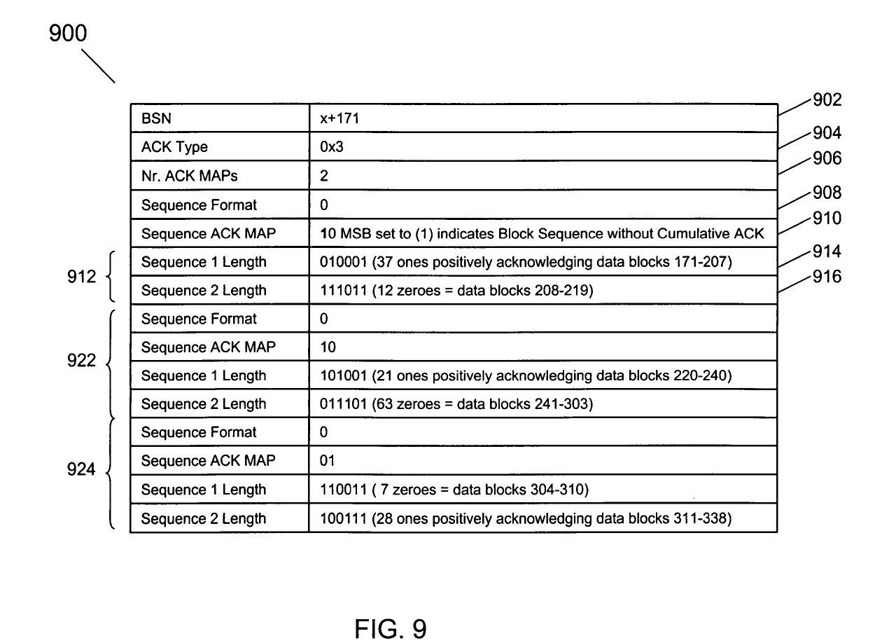

By defining a Block Sequence ACK type IE without cumulative ACK, a second IE 900 can be selected to be a Block Sequence ACK type IE without cumulative ACK as shown in FIG. 9 and can be used to provide ARQ feedback on blocks 171 to 338.

The second IE 900 comprises an ACK Type field 904 which has a value 0x3 to denote a Block Sequence type of feedback message. In an embodiment of the invention, a Block Sequence type of feedback message without cumulative ACK is distinguished from a cumulative ACK Block Sequence type of feedback message by using the MSB of the first ACK MAP field and setting this MSB to one. As discussed above, for a cumulative ACK Block Sequence type of feedback message, the MSB of the first ACK MAP field is set to zero since the sequence of data blocks described by the first sequence length field of the first map entry of the cumulative ACK Block Sequence type IE corresponds to the sequence of data blocks immediately after a cumulative ACK. This is defined in the current standard. Thus, by using the MSB set to zero additional information can be conveyed, which information can be used to indicate that the IE is a Block Sequence IE without cumulative ACK, without requiring any additional fields or bits for the ACK Type field. Thus, apart from ensuring the MAC layer can interpret the meaning of a MSB of the first ACK MAP of an IE having a value one, no major changes are required to the IEEE 802.16 standard.

Other embodiments of the invention may use other means to indicate that the ACK type is a Block Sequence Type without cumulative ACK. For example, one bit could be provided in the header of the IE to specify that the IE is a Block Sequence IE without cumulative ACK or the ACK Type field can be expanded from two bits to three bits to allow for additional ACK Types to be identified.

The second IE 900 further comprises a BSN field 902. Since the second IE 900 is a Block Sequence IE without ACK, the value x+171 in the BSN field 902 indicates that the second IE 900 provides feedback starting from data block 171. The second IE 900 further comprises a field 906 which specifies the number of ACK MAPs, which in this example is three ACK MAPs, a sequence format field 908 which identifies the format of the associated sequence ACK MAP (in this example, format 0 which indicates two sequence length fields will follow), a sequence ACK MAP field 910, sequence length fields 912 which indicate the number of data blocks that are members of the associated sequence, each sequence length field addressing up to sixty three BSNs. As mentioned above, each IE can have up to four ACK MAPs and so the fields 908-912 may be repeated up to four times in an IE.

The MSB of the ACK MAP field 910 corresponds to the first sequence length field 914 in the descriptor. The bits for succeeding length field 916 are assigned left-to-right within the map entry. The second bit of the sequence ACK MAP corresponds to the subsequent sequence 2 length field. The third bit (if present) of the sequence ACK MAP corresponds to the subsequent sequence 3 length field. The sequence ACK MAP holds two bits in case the associated sequence format field is set to 0. The sequence ACK MAP holds 3 bits in case the associated sequence format field is set to 1. The sequence ACK MAP field 910 indicates a positive or negative acknowledgment for a sequence of ARQ blocks. If a bit of the sequence ACK MAP is set to 1, it indicates that all BSNs addressed by this sequence are correctly received by the receiver. If a bit of the sequence ACK MAP is set to 0, it indicates that the BSNs addressed by the corresponding sequence length are not correctly received by the receiver.

As discussed above, in an embodiment the MSB of the first ACK MAP field 910 is set to one to indicate that the IE is a Block Sequence Type IE without cumulative ACK. By using the MSB of the first ACK MAP of the IE and setting this MSB to one in order to identify a Block Sequence Type without cumulative ACK, this means that the feedback for the first sequence of data blocks in accordance with an embodiment of the invention has to be a positive acknowledgement.

The first sequence length field 914 corresponds to a first sequence of data blocks, 171-207, and as indicated by the MSB of the ACK MAP field 910 being set to one, provides positive acknowledgement of the data blocks 171-207. In other words, if the MSB of the ACK MAP field 910 is set to one, the data block BSN in the BSN field 902 corresponds to the first sequence length field 914 i.e. the first block sequence of the IE and indicates that this block sequence has been received without error. The second sequence length field 916 corresponds to a second sequence of data blocks 208-219, and as indicated by the bit to the right of the MSB of the ACK MAP field 910 being set to zero, provides negative acknowledgement of the data blocks 208-219.

Fields 922 correspond to a second ACK MAP of the IE 900 and provide ARQ feedback information for data blocks 220-303 and fields 924 correspond to a third ACK MAP of the IE 900 and provide ARQ feedback information for data blocks 304-338.

Thus, by defining and using a Block Sequence ACK type IE in accordance with the present invention, only two IEs are required to provide ARQ feedback from the MS 14 on the data blocks with BSNs in the range 0-338 as compared to the four IEs which are required when Selective ACK type of IEs are used.

Thus, by defining a Block Sequence ACK type IE in accordance with the present invention, a Block Sequence ACK type IE can be generated and used for subsequent IEs of the same connection (i.e the same transmission window). Since a Block Sequence ACK type IE can provide more feedback information than a Selective ACK type IE, less IEs are required to provide ARQ feedback. Each extra IE needed to provide feedback can add an additional 12 byes to the feedback message. By using less IEs to provide ARQ feedback, the present invention can potentially convey feedback for more data blocks yielding a more efficient use of the medium e.g. the communication links between the MS 14 and the BS 8.

By providing an additional ACK type that does not use a cumulative ACK, the present invention provides more flexibility in how feedback information is given to the originating transmitter. The processor of the MS can select the types of IEs that are most suitable for providing feedback on the data blocks of a given receiver window, rather than being limited to the four ACK types and their restricted combinations as defined in the current IEEE 802.16 standard.

Using the MSB of the first ACK MAP field of the IE to identify the IE as a Block Sequence ACK type IE without cumulative ACK, provides a simple way of identifying a different type of ACK without requiring significant changes to the current IEEE 802.16 standard.

The present invention has been discussed with respect to a BS transmitting data blocks to a MS and the MS transmitting ARQ feedback messages on an uplink communication link to the BS. It will be appreciated that the present invention applies also to the situation when the MS transmits data blocks to a BS and the BS transmits ARQ feedback messages on a downlink communication link to the MS. Thus, the term wireless communication device as used in the claims hereafter is intended to cover a mobile station or subscriber unit and also a base station.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A communication device capable of supporting an ARQ mechanism, comprising:
a receiver for receiving messages from an originating transmitter comprising a series of sequential data blocks;
a processor coupled to said receiver, said processor configured to:
generate an ARQ feedback message comprising an information element, the information element indicating for each sequence of a plurality of sequences of the series of sequential data blocks whether each sequence of data blocks has been received, and
set at least one bit of the information element to a value to indicate that the information element provides feedback information only for sequences of data blocks beginning with a first data block of a first sequence of the plurality of sequences; and
a transmitter for transmitting the ARQ feedback message to the originating transmitter.

2. The communication device of claim 1, wherein the information element comprises a plurality of fields, and the at least one bit of the information element is part of one of the plurality of fields.

3. The communication device of claim 1, wherein the information element comprises an acknowledgement mapping (ACK MAP) field for indicating whether the corresponding sequence of data blocks of the plurality of sequences have been received, and the at least one bit of the information element is part of the ACK MAP field.

4. The communication device of claim 3, wherein the at least one bit of the information element is the most significant bit of the ACK MAP field.

5. The communication device of claim 1, wherein each of the data blocks of the series of sequential data blocks is assigned a block sequence number, the information element comprises a block sequence field and the process is further configured to set the block sequence field of the information element to the block sequence number of the first data block of the first sequence minus one.

6. A communication device capable of supporting an ARQ mechanism, comprising:
a receiver for receiving messages from an originating transmitter comprising a series of sequential data blocks;
a processor coupled to said receiver, said processor configured to:
generate feedback information for providing feedback information on the series of data blocks received by the receiver in a receiver window, the feedback information comprising at least first and second information elements, the first information element indicating for a plurality of data blocks of the series of sequential data blocks whether each of the plurality of data blocks have been received, the second information element indicating for each sequence of a plurality of sequences of data blocks of the series of sequential data blocks following the plurality of data blocks whether each sequence of data blocks has been received, and
set at least one bit of the second information element to a value to indicate that the second information element provides feedback information only for sequences of data blocks beginning with a first data block of a first sequence of the plurality of sequences; and
a transmitter for transmitting the feedback information to the originating transmitter.

7. The communication device of claim 6, wherein the second information element comprises an acknowledgement mapping (ACK MAP) field for indicating whether the corresponding sequence of data blocks of the plurality of sequences have been received, and the at lest one bit of the second information element is part of the ACK MAP field.

8. The communication device of claim 7, wherein the at least one bit is the most significant bit of the ACK MAP field.

9. The communication device of claim 6, wherein the first and second information elements are transmitted in different feedback messages.

10. The communication device of claim 6, wherein at least one of the first and second information elements is included in a feedback message including at least one additional information element, said at least one of the first and second information elements for a different connection than said at least one additional information element.

11. A communication device capable of supporting an ARQ mechanism, comprising:
a receiver for receiving messages from an originating transmitter comprising a series of sequential data blocks;
a processor coupled to said receiver, said processor configured to:
generate an ARQ feedback message comprising an information element, the information element for indicating for each sequence of a plurality of sequences of data blocks of the series of sequential data blocks whether each sequence of data blocks has been received, and
set at least one bit of the information element to a value to indicate that the information element is a Block Sequence ARQ type information element without cumulative feedback; and
a transmitter for transmitting the ARQ feedback message to the originating transmitter.

12. The communication device of claim 11, wherein the information element comprises a plurality of fields, and the at least one bit of the information element is part of one of the plurality of fields.

13. The communication device of claim 11, wherein the information element comprises an acknowledgement mapping (ACK MAP) field for indicating whether the corresponding sequence of data blocks of the plurality of sequences have been received, and the at least one bit of the information element is part of the ACK MAP field.

14. The communication device of claim 13, wherein the at least one bit of the information element is the most significant bit of the ACK MAP field.

15. A method of operating a communication device, the communication device being capable of supporting an ARQ mechanism, the method comprising the steps of:
receiving messages from an originating transmitter comprising a series of sequential data blocks;
generating an ARQ feedback message comprising an information element, the information element indicating for each sequence of a plurality of sequences of the series of sequential data blocks whether each sequence of data blocks has been received, and the information element having at least one bit set to a value to indicate that the information element provides feedback information only for sequences of data blocks beginning with a first data block of a first sequence of the plurality of sequences; and
transmitting the ARQ feedback message to the originating transmitter.

16. The method of claim 15, wherein the information element comprises a plurality of fields, and the at least one bit of the information element is part of the plurality of fields.

17. The method of claim 15, wherein the information element comprises an acknowledgement mapping (ACK MAP) field for indicating whether the corresponding sequence of data blocks of the plurality of sequences have been received, and the at least one bit of the information element is part of the ACK MAP field.

18. The method of claim 17, wherein the at least one bit of the information element is the most significant bit of the ACK MAP field.

19. A communication system comprising:
an originating transmitter for transmitting messages comprising a series of sequential data blocks; and
a communication device capable of supporting an ARQ mechanism, the communication device comprising:
a receiver for receiving messages from the originating transmitter;
a processor coupled to said receiver, said processor configured to:
generate an ARQ feedback message comprising an information element, the information element indicating for each sequence of a plurality of sequences of the series of sequential data blocks whether each sequence of data blocks has been received, and
set at least one bit of the information element to a value to indicate that the information element provides feedback information only for sequences of data blocks beginning with a first data block of a first sequence of the plurality of sequences; and
a transmitter for transmitting the ARQ feedback message to the originating transmitter.

20. An ARQ feedback message for providing feedback information on a series of sequential data blocks received by a receiver, the ARQ feedback message comprising an information element, the information element indicating for each sequence of a plurality of sequences of the series of sequential data blocks whether each sequence of data blocks has been received, wherein the information element comprises at least one bit for indicating that the information element provides feedback information only for sequences of data blocks beginning with a first data block of a first sequence of the plurality of sequences.

21. The ARQ feedback message of claim 20, wherein the information element further comprises a plurality of fields, and the at least one bit of the information element is part of one of the plurality of fields.

22. The ARQ feedback message of claim 20, wherein the information element further comprises an acknowledgement mapping (ACK MAP) field for indicating whether the corresponding sequence of data blocks of the plurality of sequences have been received, and the at least one bit of the information element is part of the ACK MAP field.

23. The ARQ feedback message of claim 22, wherein the at least one bit of the information element is the most significant bit of the ACK MAP field.

24. The ARQ feedback message of claim 20, wherein each of the data blocks of the series of sequential data blocks is assigned a block sequence number, the information element further comprises a block sequence field, the block sequence field of the information element having a value corresponding to the block sequence number of the first data block of the first sequence minus one.
